(19) United States
(12) Patent Application Publication
(10) Pub. No.: US 2016/0235609 A1
(43) Pub. Date: Aug. 18, 2016

(54) HOST STRUCTURE FOR LYING PERSONS AND VEHICLE PROVIDED WITH SUCH A STRUCTURE

(71) Applicant: NEXTER SYSTEMS, Roanne (FR)

(72) Inventor: Alain HUBSCH, Roanne (FR)

(73) Assignee: NEXTER SYSTEMS, Roanne (FR)

(21) Appl. No.: 15/045,514

(22) Filed: Feb. 17, 2016

(30) Foreign Application Priority Data
Feb. 17, 2015 (FR) 1500309

(51) Int. Cl. A61G 1/06

(52) U.S. Cl. CPC A61G 1/06

(57) ABSTRACT

The invention relates to a host structure (1) for lying persons and a vehicle provided with such a structure, the structure (1) comprising at least two stretcher supports (2a, 2b, 2c) moveable along a circuit (5a) defined by guiding means (5) parallel to each other. The ends of each stretcher support (2a, 2b, 2c) are attached via a pivot connection (6) to a connecting means (15) which is guided by one of the guiding means (5), each guiding means (5) being conformed so as to form a closed circuit (5a) to allow a circular permutation of the stretcher supports (2a, 2b, 2c).

The technical field of the invention is that of the structures intended to accommodate lying persons in stretchers, such as injured persons. Such structures can be found on board of ambulances as a medical compartment for carrying injured persons and providing first aid.

The space on board of these embedded structures is reduced, and in order to be capable to carry a maximum number of injured persons while positioning them to make them sufficiently accessible for them to be taken care of, it is necessary that one be able to handle the stretchers with the injured persons within the structure accommodating them.

The utility model DE202009008363thus describes a host structure comprising two superposed stretcher supports which can be vertically and horizontally moved by means of parallel rectilinear rails forming slides, the rails being arranged along a flat wall of the structure.

Such rails have the disadvantage that they cannot allow the optimum use of the volume of the structure if the structure has not a flat profile at the vicinity of the rails. Further, the exclusively rectilinear translation displacement of the stretcher supports according to the direction of the rails does not allow switching the position of the injured persons to make all of them accessible in a similar manner to a caregiver sitting beside.

Thus, the invention relates to a host structure for lying persons, the structure comprising at least two stretcher supports moveable along a circuit defined by guiding means parallel to each other, the host structure being characterized in that the ends of each stretcher support are attached via a pivot connection to a connecting means which is guided by one of the guiding means, each guiding means being conformed so as to form a closed circuit to allow a circular permutation of the stretcher supports.

According to one embodiment, each guiding means has at least one rail which guides the translation of the connecting means, wherein the axis of the pivot connection remains, during this guiding, parallel to a longitudinal direction of the stretcher support.

According to another embodiment, each guiding means has pulleys and at least one flexible link guided by the pulleys, the connecting means being attached to the flexible link, each pivot connection remaining parallel to a longitudinal direction of the stretcher support.

Advantageously, the mobility of the stretcher supports is provided by a motorization.

Advantageously, the stretcher supports are connected to each other so that the movement of one stretcher support along the circuit formed by the guiding means causes the movement of the other stretcher supports.

Advantageously, the movement of the stretcher supports with respect to the guiding means can be blocked.

The invention also relates to a sanitary vehicle, characterized in that the sanitary vehicle has at least one host structure comprising one of the preceding features.

Advantageously, the guiding means are positioned such that the stretcher supports remain throughout their path at a minimum distance D from a wall of the vehicle.

Advantageously, the stretcher supports are arranged parallel to a longitudinal axis of the vehicle.

The invention will become more apparent upon reading the following description made with reference to the appended drawings in which:

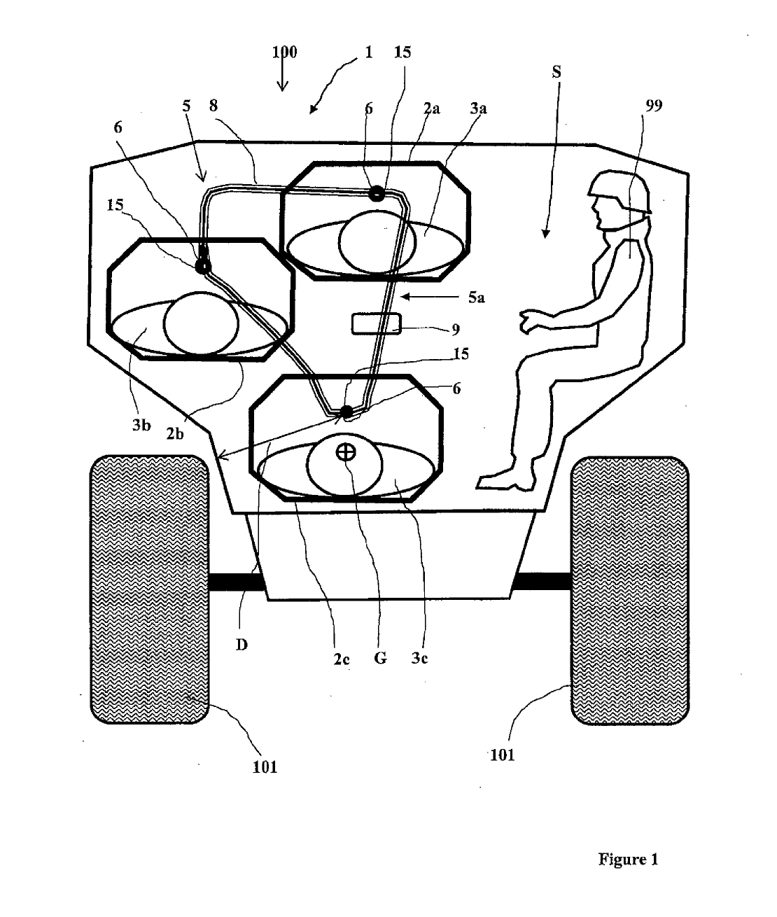

FIG. 1 shows a cross-sectional view of a vehicle comprising a host structure according to the invention.

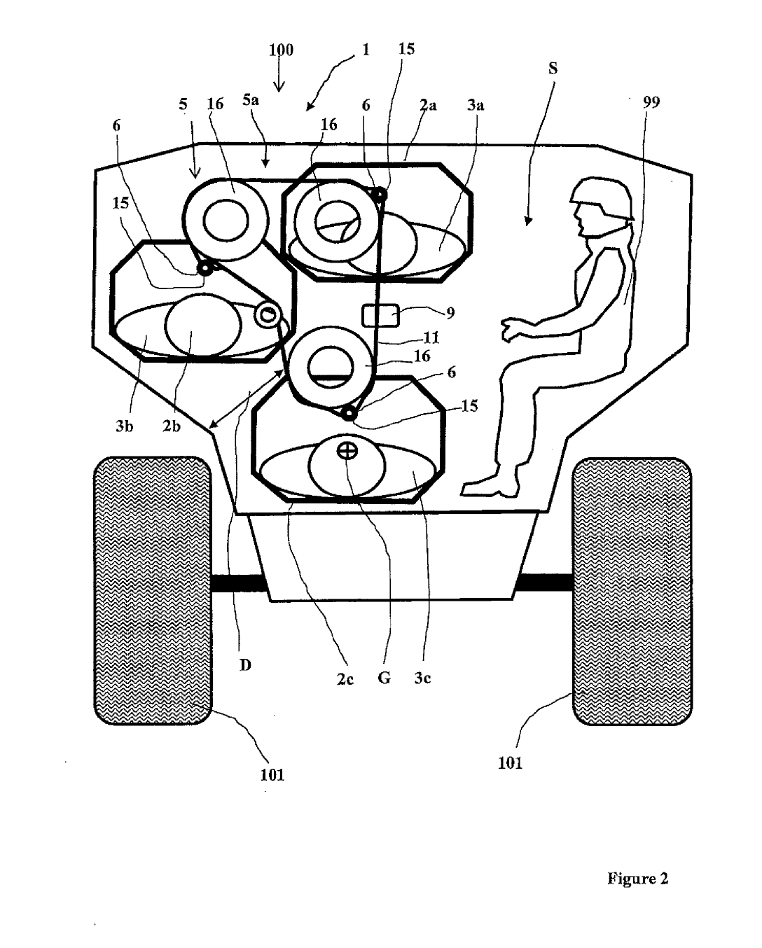

FIG. 2 shows a cross-sectional view of a vehicle comprising a host structure according to a second embodiment of the invention.

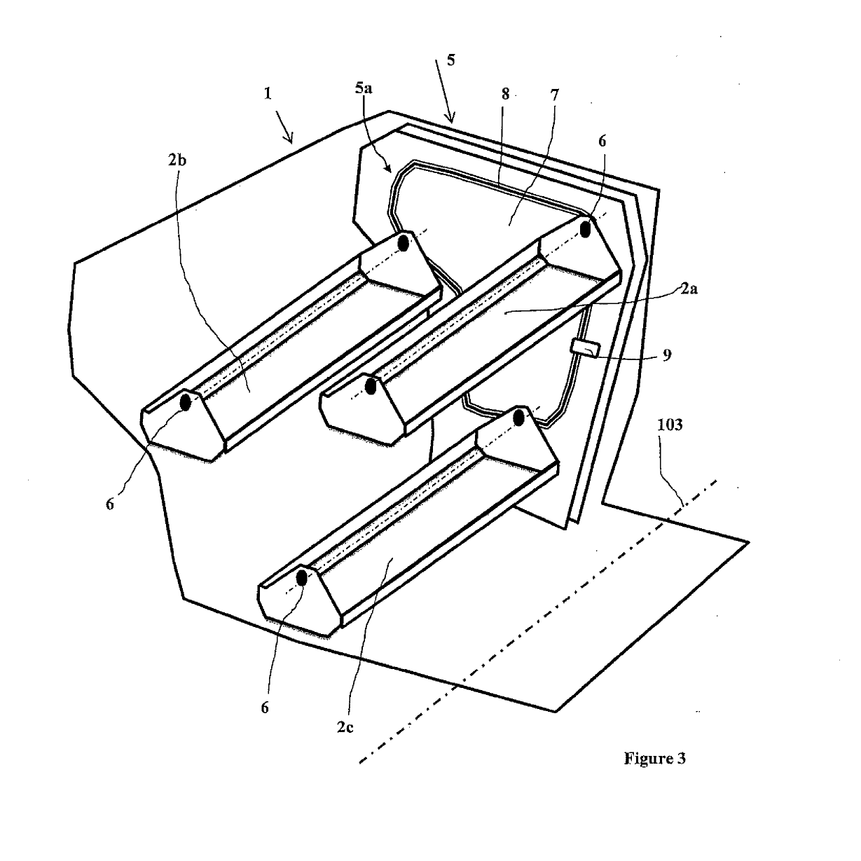

FIG. 3 shows a partially cutaway three-quarter view of a host structure according to the invention.

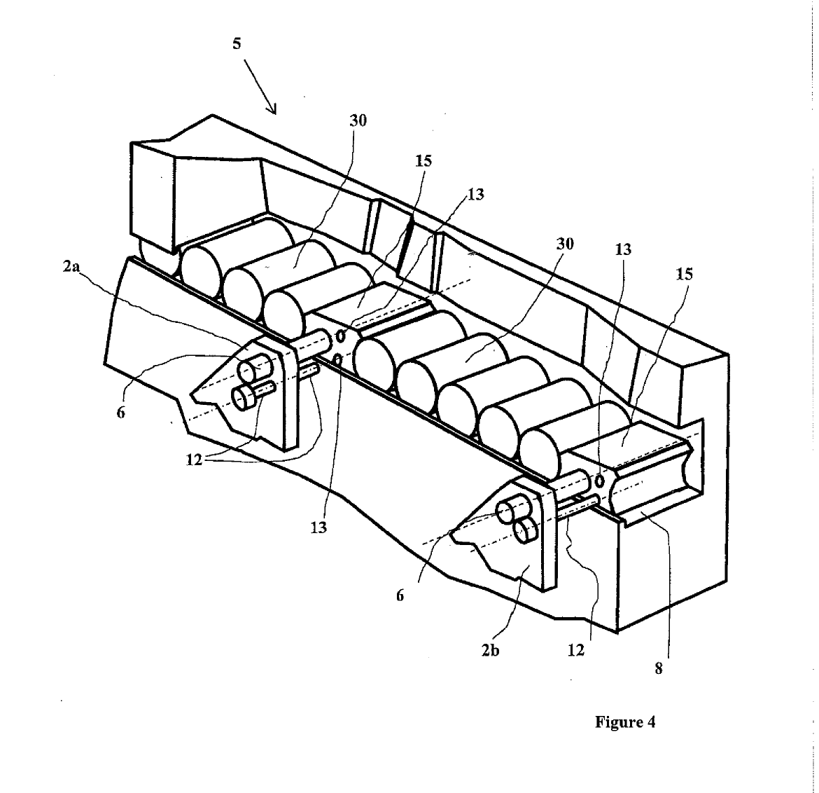

FIG. 4 shows a partially cutaway three-quarter detailed view of a host structure according to the invention.

According to FIG. 1, a vehicle 100 with wheels 101 has a host structure 1 with a prismatic section arranged within a compartment of the vehicle comprising an enlarged part extending above the wheels 101 and a narrower part arranged between the wheels 101. The host structure 1 has three pod-shaped stretcher supports 2a, 2b, 2c for accommodating lying persons 3a, 3b, 3c who can be injured. A carrying stretcher (not shown) can be arranged in each stretcher support. It will also be possible to place the injured person directly in the stretcher support which will then be provided with cloth or foam layers ensuring his/her comfort.

The stretcher supports 2a, 2b, 2c are parallel to each other and are oriented parallel to a longitudinal axis 103 of the vehicle 100 (axis of the vehicle visible in FIG. 3).

The host structure 1 has guiding means 5, parallel to each other, and located at the ends of the stretcher supports 2a, 2b, 2c. The guiding means 5 are integral with walls (walls not shown) of the host structure 1. The guiding means 5 could also be attached to the walls of the vehicle or to intermediary frames 7, such as the frame visible in FIG. 3 and which makes the guiding means 5 integral with the floor of the vehicle for example (only one of both required frames 7 is shown in FIG. 3).

As shown in FIGS. 1, 2 and 4, each stretcher support 2a, 2b, 2c has, at each of its ends, a connecting means 15 which carries a pivot connection 6 parallel to a longitudinal axis of the stretcher support 2a, 2b, 2c. Each pivot connection 6 is located above the center of gravity G of the stretcher support 2a, 2b, 2c so as to ensure the pendulum stability of said support, particularly when said support is occupied.

According to the embodiment of FIG. 1, the guiding means 5 have rails 8 forming a closed circuit 5a. These rails 8 are intended to guide the translation of the connecting means 15 which carry the pivot connections 6 throughout the circuit 5a thus formed.

The rail 8 can thus follow a substantially curvilinear path in correspondence of and at a distance D from the inner wall of the vehicle, so as to be capable of bringing a stretcher support 2a, 2b, 2c to areas within the vehicle having a habitability and a reduced accessibility such as in the enlarged upper part of the passenger compartment, for example. The distance D between the rail 8 and the inner wall of the passenger compartment is selected so as not to have interferences between the stretcher supports 2a, 2b, 2c and the inner profile of the passenger compartment throughout the path of the circuit 5a formed by the rail 8 of the guiding means 5.

Further, a circular permutation of the stretcher supports 2a, 2b, 2c can thus be performed so as to bring a selected stretcher support 2a, 2b, 2c close to a caregiver 99 placed in a care area S of the passenger compartment so that he/she can provide care in the best ergonomic and access conditions to the injured person 3a, 3b, 3c.

It is obvious for the person skilled in the art that motor means such as a motorization (motor means not shown) could be added to the host structure 1, and in particular to the guiding means 5 so as to move the stretcher supports 2a, 2b, 2c without any physical efforts.

The stretcher supports 2a, 2b, 2c can be spaced apart from each other by an interval that is constant along the circuit 5a of the guiding means 5 so as not to create interferences between the stretcher supports 2a, 2b, 2c and to allow the movement of only one stretcher support to cause a movement with the same extent of the other stretcher supports 2a, 2b, 2c.

This constant spacing and driving means between the stretcher supports 2a, 2b, 2c can be provided, for example, by chocking means 30 shown in FIG. 4, which can comprise for example a series of contiguous rollers 30 contained in each rail 8 and located between each connecting means 15 of the successive pivot connections 6. As it can be seen in FIG. 4, the connecting means 15 has cylindrical profiles cooperating with rollers 30 for allowing the pivoting and rolling of the rollers. The connecting means 15 will generally have a parallelepiped shape and will slide in the rail 8 by means of a suitable clearance.

The host structure 1 can have at least one blocking means 9, such as a brake, preventing the permutation movement of the stretcher supports 2a, 2b, 2c during the transport or care phases, for example.

Each stretcher support 2a, 2b, 2c can also have, at a connecting means 15 of a pivot connection 6, a stop means 12 preventing the stretcher supports 2a, 2b, 2c from swinging when the permutation movement is blocked, thereby allowing to stabilize the position of the injured person if his/her condition or the care needs it.

Such stop means 12 can have a blocking rod 12 capable of sliding in a part of a stretcher support 2a to be able to engage or not, depending on a selection of the user, in a bore 13 of a connecting means 15. The connecting means 15 will have several bores 13 to allow immobilizing the swing of the stretcher supports 2a, 2b, 2c for different orientations of the connecting means 15 adopted during the path thereof along the circuit 5a and with respect to the stretcher support 2a. In FIG. 4, only two bores 13 on each connecting means 15 are shown.

According to a second embodiment shown in FIG. 2, the guiding means 5 has pulleys (or toothed wheels) 16 intended to guide a closed flexible link 11 (such as a chain or a belt). This flexible link 11 is guided by the pulleys or wheels and carries the connecting means 15 of the pivot connections 6, and allows the simultaneous drive of all the stretcher supports 2a, 2b, 2c along the closed circuit 5a defined by the position of the pulleys or toothed wheels 16.

Such a flexible link 11 also allows providing a fixed interval between the stretcher supports 2a, 2b, 2c, the interval being selected once again so as to prevent interferences between the stretcher supports 2a, 2b, 2c.

The path of the flexible links 11 between the pulleys 16 or wheels is arranged such that the stretcher supports 2a, 2b, 2c can perform a circular permutation movement between the different useful positions on board of the vehicle.

Host structures comprising three stretcher supports have been shown in the figures. It is of course possible, depending on the available volume, to define a host structure comprising a greater number of stretcher supports.

1- A host structure (1) for lying persons, the structure (1) comprising at least two stretcher supports (2a, 2b, 2c) moveable along a circuit (5a) defined by guiding means (5) parallel to each other, wherein the ends of each stretcher support (2a, 2b, 2c) are attached via a pivot connection (6) to a connecting means (15) which is guided by one of the guiding means (5), each guiding means (5) being conformed so as to form a closed circuit (5a) to allow a circular permutation of the stretcher supports (2a, 2b, 2c).

2- The host structure (1) according to claim 1, wherein each guiding means (5) has at least one rail (8) which guides the translation of the connecting means (15), wherein the axis (6) of the pivot connection (6) remains, during this guiding, parallel to a longitudinal direction of the stretcher support (2a, 2b, 2c).

3- The host structure (1) according to claim 1, wherein each guiding means (5) has pulleys (16) and at least one flexible link (11) guided by the pulleys (16), the connecting means (15) being attached to the flexible link (11), each pivot connection (6) remaining parallel to a longitudinal direction of the stretcher support (2a, 2b, 2c).

4- The host structure (1) according to claim 1, wherein the mobility of the stretcher supports (2a, 2b, 2c) is provided by a motorization.

5- The host structure (1) according to claim 1, wherein the stretcher supports (2a, 2b, 2c) are connected to each other so that the movement of one stretcher support (2a, 2b, 2c) along the circuit (5a) formed by the guiding means (5) causes the movement of the other stretcher supports (2a, 2b, 2c).

6- The host structure (1) according to claim 1, wherein the movement of the stretcher supports (2a, 2b, 2c) with respect to the guiding means (5) can be blocked.

7- A sanitary vehicle (100) having at least one host structure (1) according to claim 1.

8- The sanitary vehicle (100) according to claim 7, wherein the guiding means (5) are positioned such that the stretcher supports (2a, 2b, 2c) remain throughout their path at a minimum distance D from a wall of the vehicle (100).

9- The sanitary vehicle (5) according to claim 7, wherein the stretcher supports (2a, 2b, 2c) are arranged parallel to a longitudinal axis of the vehicle (100).
